(19) United States
(12) Patent Application Publication
(10) Pub. No.: US 2017/0050413 A1
(43) Pub. Date: Feb. 23, 2017

(54) KIND OF PRODUCTION PROCESS FOR A FULLY COVERED LEATHER SHEATH PRODUCT

(71) Applicant: SENG TONG GROUP (INTERNATIONAL) BROTHERS INVESTMENT LIMITED, HONG KONG (CN)

(72) Inventor: JIN QIANG LIAO, HONG KONG (CN)

(21) Appl. No.: 14/830,321

(22) Filed: Aug. 19, 2015

(51) Int. Cl. B32B 9/02; B32B 37/10; C14B 7/02; C14B 1/28; C14B 1/30; B32B 37/06; B32B 37/12

(52) U.S. Cl. CPC B32B 9/025; B32B 37/06; B32B 37/10; B32B 37/1207; C14B 1/28; C14B 1/30; C14B 7/02; B32B 2037/1215

(57) ABSTRACT

The present invention discloses a kind of production process for a fully covered leather sheath product, which comprises the following steps of: determining peripheral dimensions of leather such as the length and width according to the size of the product, and coating the leather with an adhesive; putting the shell of a product to be covered into the upper die of a mold, placing the trimmed leather into the lower die of the mold, and positioning it by a positioning post; heating the above-mentioned leather placed in the lower die of the mold; closing the upper die and the lower die immediately after the heating treatment is complete; opening the mold until the lamination is complete, taking out the product from the mold and fitting it with a fixture for the stretching folding treatment; heating the product along with the fixture to bond the leather with the interior of the product shell; and pressing it along with the fixture after heating; taking the pressed product out of the fixture and cutting excessive leather, attaching an inner lining material of the same dimensions after the excessive leather is cut, and pressing the inner lining material for bonding. The objective of the present invention is to provide a production process for the fully covered leather sheath product, which has high production efficiency and can improve the overall product design effect.

### TECHNICAL FIELD

The present invention relates to the field of leather sheath products, particularly to a kind of production process for a fully covered leather sheath product.

### BACKGROUND

At present, leather products commercially available fall mainly into the following groups: conventional leather products sewn from sewing machines; hot pressed leather products and shell-laminated leather products; in addition to easy imitation, most products are mature in terms of structure and process, which has taken all the details into consideration, leading to fierce competition in market; currently, commercially available products of the same category are manually made, resulting in easily-creased edges of products and low production capacity, and the thinnest PC shell available is only 1.0 MM in thickness.

### SUMMARY OF THE INVENTION

The embodiments of the present invention solve the technical problem to provide a production process for a fully covered leather sheath product, which has high production efficiency and can improve the whole product design effect.

The production process for the fully covered leather sheath product comprises the following steps of:

(1) determining peripheral dimensions of the leather such as the length and width according to the size of a product, and coating the leather with an adhesive;

(2) putting the shell of the product to be covered into the upper die of a mold, placing the trimmed leather into the lower die of the mold and positioning it by a positioning post;

(3) heating the above-mentioned leather placed in the lower die of the mold;

(4) closing the upper die and the lower die immediately after the heating treatment is complete;

(5) opening the mold until the lamination is complete, taking out the product from the mold and fitting with a fixture for the stretching folding treatment;

(6) heating the above-mentioned product along with the fixture to bond the leather with the interior of the product shell;

(7) pressing it along with the fixture after heating;

(8) taking the pressed product out of the fixture and cutting excessive leather;

(9) attaching an inner lining material of the same dimensions after the excessive leather is cut, and pressing the inner lining material for bonding.

As a further improvement of the technical solution, the adhesive is a hot melt adhesive.

The product to be covered is a mobile phone shell or a PC shell.

For implementing the embodiment of the present invention, there are the following beneficial effects that:

the embodiment of the present invention utilizes fully covering process for a new structure; this process adopts one layer of leather (including genuine leather/PU) to fully cover an ultrathin plastic protection shell, the selection of leather materials at present is limited within the leather with elasticity that has passed a tensile test. As adhesive medium, the hot melt adhesive is used between the hard shell and the leather that is stretched at suitable temperature for the lamination; (this step requires heating/stretching for lamination to be completed in the same equipment and mold); the above-mentioned conditions can be suitable for the size and shape of the product except that there is special requirement for leather; the seamless joint type lamination is utilized to process the inner lining material (i.e. the leather is folded reversely, followed by the excessive leather being cut, then the inner lining material is laminated according to the exact size after cutting, which solves completely the problem of height difference between the fabric and the inner lining material to level them); the whole manufacturing process is carried out in a die equipment, which not only saves human labor but also makes the products more stable; and it is difficult to be imitated; the edges of products manufactured by the process are not creased, the outside PU is covered to the interior and is jointed with the lining without being overlapped, the gap is smaller than 0.5 mm, which greatly promotes the appearance and quality. The thickness of the PC shell can be as thin as 0.8 MM to maximum extent, which can improve the whole product design effect.

### DETAILED DESCRIPTION OF THE INVENTION

To make the object, technical solution and advantages of the present invention more clear, the present invention will be described in further detail.

The embodiment of the present invention of the production process for a fully covered leather sheath product comprises the following steps:

(1) determining peripheral dimensions of the leather such as the length and width according to the size of a product, and coating the leather with an adhesive;

(2) putting the shell of the product to be covered into the upper die of a mold, placing the trimmed leather into the lower die of the mold and positioning it by a positioning post;

(3) heating the above-mentioned leather material placed in the lower die of the mold;

(4) closing the upper die and the lower die immediately after the heating treatment is complete;

(5) opening the mold after the lamination is complete, taking out the product from the mold and fitting it with a fixture for the stretching folding treatment;

(6) heating the above-mentioned product along with the fixture to bond the leather material with the interior of the product shell;

(7) pressing it along with the fixture after heating;

(8) taking the pressed product out from the fixture and cutting excessive leather; and

(9) attaching the inner lining material of the same dimensions after the excessive leather is cut, and pressing the inner lining material for bonding.

As a further improvement of the technical solution, said adhesive is a hot melt adhesive.

Said product to be covered is a mobile phone shell or a PC shell.

The embodiment of the present invention utilizes fully covering process for a new structure; this process adopts one layer of leather (including genuine leather/PU) to fully cover an ultrathin plastic protection shell, the selection of leather materials at present is limited within the leather with elasticity that has passed a tensile test. As adhesive medium, the hot melt adhesive is used between the hard shell and the leather that is stretched at suitable temperature for the lamination; (this step requires heating/stretching for lamination to be completed in the same equipment and mold); the above-mentioned conditions can be suitable for the size and shape of the product except that there is special requirement for leather; the seamless joint type lamination is utilized to process the inner lining material (i.e. the leather is folded reversely, followed by the excessive leather being cut, then the inner lining material is laminated according to the exact size after cutting, which solves completely the problem of height difference between the fabric and the inner lining material to level them); the whole manufacturing process is carried out in a die equipment, which not only saves human labor but also makes the products more stable; and it is difficult to be imitated; the edges of products manufactured by the process are not creased, the outside PU is covered to the interior and is jointed with the lining without being overlapped, the gap is smaller than 0.5 mm, which greatly promotes the appearance and quality. The thickness of the PC shell can be as thin as 0.8 MM to maximum extent, which can improve the whole product design effect.

Above disclosure is only a kind of preferred embodiment of the present invention, and cannot certainly limit the scope of protection of the utility model with this, thus the equivalent variations done according to the utility model claim still belongs to the scope that the utility model is contained.

1. A production process for a fully covered leather sheath product, characterized in that, comprising the following steps of:
(1) determining peripheral dimensions of leather such as the length and width according to the size of the product, and coating the leather with an adhesive;
(2) putting the shell of a product to be covered into the upper die of a mold, placing the trimmed leather into the lower die of the mold, and positioning it by a positioning post;
(3) heating the above-mentioned leather placed in the lower die of the mold;
(4) closing the upper die and the lower die immediately after the heating treatment is complete;
(5) opening the mold until the lamination is complete, taking out the product from the mold, and fitting with a fixture for the stretching folding treatment;
(6) heating the product along with the fixture to bond the leather with the interior of the product shell;
(7) pressing it along with the fixture after heating;
(8) taking the pressed product out of the fixture and cutting excessive leather;
(9) attaching an inner lining material of the same dimensions after the excessive leather is cut, and pressing the inner lining material for bonding.

2. The production process for a fully covered leather sheath product according to claim 1, characterized in that: said adhesive is a hot melt adhesive.

3. The production process for a fully covered leather sheath product according to claim 1, characterized in that: said product to be covered is a mobile phone shell or a PC shell.
